(19) United States
(12) Patent Application Publication
(10) Pub. No.: US 2022/0332546 A1
(43) Pub. Date: Oct. 20, 2022

(54) ELEVATOR INSTALLATION

(71) Applicant: Inventio AG, Hergiswil (CH)

(72) Inventor: Romeo Lo Jacono, Gravesano (CH)

(21) Appl. No.: 17/754,064

(22) PCT Filed: Sep. 1, 2020
(86) PCT No.: PCT/EP2020/074264

§ 371 Date: Mar. 23, 2022

(30) Foreign Application Priority Data
Sep. 30, 2019 (EP) 19200473.7

(51) Int. Cl. B66B 13/28

(52) U.S. Cl. CPC B66B 13/285

(57) ABSTRACT

An elevator installation includes an elevator shaft provided with shaft doors and a car moveable up and down in the shaft. The car has a car skirt moveable between a horizontal rest position and a vertical blocking position. The car skirt is pivotally and displaceably mounted on the car by a guideway. When the car skirt is in the blocking position, it can be supported on an adjacent one of the shaft doors.

The invention relates to an elevator installation according to the preamble of claim 1.

Elevator installations for conveying people and goods contain cabins that can be moved up and down in an elevator shaft. The cabins can be moved by means of a drive unit using suspension means, for example in the form of suspension cables or suspension belts. As a result of malfunctions or emergency stops, the cabin may become stuck between the floors. In such incidents, the trapped people must be evacuated from the cabin to the next stop. In this case, a gap could arise between the underside of the cabin and the floor, and people could fall through this gap during the evacuation into the shaft. In order to avoid such incidents, the cabins are equipped with cabin skirts. There are various sets of rules with precise specifications for the design of cabin skirts for the elevator industry. Rigid cabin skirts have been known and used for a long time. European standard EN 81-20:2014 stipulates in section 5.4.5 that the vertical length of the skirt must be at least 750 mm and that the skirt must be designed to be so stable that there is virtually no yielding in the case of a force of 300 N applied at a point.

For some time now, elevator installations with reduced shaft pit depths have become increasingly popular. In order to allow the shaft pit depth to be reduced, the cabin skirts are designed to be movable. Pivotable and foldable cabin skirts are known from EP 1 118 576 A2. In practice, it has been shown that the high requirements in terms of stability can be achieved only with great effort with the known cabin skirts.

It is therefore an object of the present invention to avoid the disadvantages of the known elevator installation and in particular to provide an elevator installation with which the evacuation of people from the cabin can be ensured in a safe manner. In particular, the cabin skirt used for this purpose should be simple and inexpensive and meet high stability requirements.

According to the invention, this problem is solved by an elevator installation having the features of claim 1. The elevator installation comprises an elevator shaft and a cabin that can be moved up and down in the elevator shaft preferably along guide rails. The cabin has a movable cabin skirt, the cabin being able to be moved between a horizontal rest position and a vertical blocking position. The cabin skirt, when it is in the blocking position, can be supported on one of the shaft doors. Movable cabin skirts are particularly advantageous for elevator installations with shallow pit depths or for elevators without a pit. Shaft doors can be provided on each floor in order to allow passengers and goods access to the cabin.

The cabin skirt is designed in such a way that there are a plurality of advantages resulting from the fact that said skirt, when it is in the blocking position, can be supported on one of the shaft doors when horizontal forces are exerted from the outside by people getting out of the cabin interior for evacuation. The cabin skirt is characterized by a high level of stability. By virtue of the support, it is ensured that undesired yielding into the shaft interior can be easily prevented by the floor-side action on the cabin skirt, for example if a person presses against the skirt as a result of falling during an evacuation of people from the cabin. Furthermore, the arrangement makes it possible, in a reliable manner, for even strict standard requirements to be easily met. Elaborate and costly structural measures for the stable and rigid attachment of the cabin skirt to the cabin can be dispensed with. In particular, it is not necessary to provide additional or special locking means in order to secure the blocking position of the cabin skirt.

In the rest position, the cabin skirt can be positioned in a substantially horizontal position below the cabin close to the underside of the cabin; in the blocking position, the cabin skirt for blocking the gap between the cabin and the floor can preferably be directed in a vertical position downward toward the shaft pit, the cabin skirt preferably extending in parallel with the shaft wall on the shaft door side.

The rest position corresponds to a position for normal operation, in which position the cabin skirt is positioned close to an underside of the cabin. In this rest position, there would be a gap between the cabin and the floor if the cabin were to become stuck between the floors. This gap must be closed in order to safely evacuate the trapped people from the cabin. To do this, the cabin skirt is moved down into the blocking position. The blocking position is the position for closing the gap between the floor and the underside of the cabin, thus preventing people from falling from the floor into the elevator shaft via an open shaft door.

Two guide rails for guiding the cabin can be provided in the elevator shaft. The guide rails can preferably be arranged opposite one another on corresponding shaft walls of the elevator shaft.

The cabin can also have a cabin door. The cabin can have a front side, a rear side opposite the front side and a parallel cabin side connecting the front side and rear side. As a rule, the cabin door and thus also the cabin skirt are arranged in the region of the front side.

Guide rails for guiding the cabin can be attached to shaft walls which are adjacent to the above-mentioned two parallel cabin sides. The guide rails can be positioned in the shaft in such a way that, in a top view, they lie approximately in the center of these cabin sides.

Controllable or manually operable securing means can be provided on the cabin, by means of which securing means the cabin skirt is held in the rest position securely on the cabin in the horizontal position close to the underside of the cabin. The cabin skirt can also be designed in such a way that, after it has been enabled or released by appropriate control or operation of the securing means, the cabin skirt can be moved into the blocking position.

The cabin skirt can preferably be designed to be movable about a horizontal pivot axis. The cabin skirt can also have a blocking segment which projects downward in the blocking position in order to close the gap between the floor and the underside of the cabin and a support segment which adjoins the blocking segment at the pivot axis and projects upward in the blocking position in order to positionally secure the vertical position of the cabin skirt. The support segment is the element of the cabin skirt which is supported on the shaft doors when horizontal forces are exerted from the outside for example by people getting out of the cabin interior during an evacuation. When the stated force is exerted, the free upper end of the support segment abuts the relevant shaft door and thus prevents an undesired movement of pivoting further backward.

The cabin skirt can be a flat skirt element, the flat skirt element comprising the aforementioned blocking segment and the support segment which adjoins said blocking segment and is preferably on the same plane. When the cabin skirt is in the blocking position, the support segment forms a stop to prevent the cabin skirt from pivoting back toward the underside of the cabin when horizontal forces are exerted from the outside by people getting out of the cabin interior.

To a certain extent, the support segment forms a protruding part of the cabin skirt. To reliably ensure a stable blocking position of the cabin skirt, it is advantageous if the support segment has a length of at least 10 cm. The length mentioned is measured starting from the pivot axis as far as the free end or the upper edge of the cabin skirt.

In a preferred embodiment, the cabin skirt is pivotally and displaceably mounted by means of a guideway. Thanks to the pivoting and sliding movement, it is easily possible to move the cabin skirt from the rest position, in which the cabin skirt is positioned below the cabin in a horizontal position close to the underside of the cabin, and into the blocking position, in which the cabin skirt extends in a vertical position in parallel with the shaft wall on the shaft door side and close to the shaft door.

The guideway can be formed, for example, by a groove or a rail. The cabin preferably has two opposite guide grooves or guide rails, the guide grooves or guide rails being arranged in the region of the cabin floor on the opposite parallel cabin sides.

The guideway can have a guide portion. Using the guide portion, the cabin skirt can be easily displaced and thus the horizontal distance to the shaft door can be easily bridged. The guide portion can have a linear or curved course.

The guideway can have an oblique, preferably linear, guide portion. The oblique guide portion is inclined with respect to the horizontal. The oblique course ensures that the cabin skirt can be moved into the blocking position due to the force of gravity. After being enabled or released by appropriate control or operation of the securing means, the cabin skirt can be automatically, and only under the effect of gravity, brought into the blocking position.

Furthermore, the guideway can have a vertical end portion which adjoins the guide portion. The end portion ensures that the cabin skirt cannot easily be pushed back by applying a horizontal force. To restore the initial position, the skirt must first be lifted, i.e., moved slightly upward in a vertical direction until a curve point is reached from which the skirt can be displaced further backward by the guide portion, the skirt being pivoted upward during or after the second-mentioned sliding movement.

The end portion, which is preferably short in comparison with the guide portion, can have a linear or curved course.

The end portion can have a front end for setting the blocking position. This front end corresponds to an end point of the guideway. The front end forms the lowest point of the guideway so that the pivot axis of the cabin skirt is temporarily fixed. The front end of the end portion is positioned in such a way that, in the blocking position, the vertical cabin skirt extends close to and almost in parallel with the shaft door. Temporarily fixed here means that when horizontal forces are exerted, the cabin skirt can only be pivoted. However, since the front end of the end portion is preferably arranged so close to the shaft wall on the shaft door side, the pivoting movement is substantially prevented or only a slight pivoting movement is possible since the shaft door abuts the shaft door.

The cabin skirt can have a pair of articulated cams for setting the pivot axis, which cams engage in a pair of parallel guide grooves on the cabin that form the guideway. Of course, other structural configurations are also conceivable. For example, the cabin skirt can have a continuous axle shaft for setting the pivot axis that engages in guide grooves on the cabin.

The cabin skirt can have a central, preferably approximately rectangular, cutout in the region of the support segment. Such a design can make sure that the support segment has a sufficient length, but due to the cutout, there is no disruptive obstacle at the door threshold. This ensures that the cabin opening is completely free when the cabin doors are open, even with extra-long support segments.

Further individual features and advantages of the invention can be derived from the following description of embodiments and from the drawings, in which

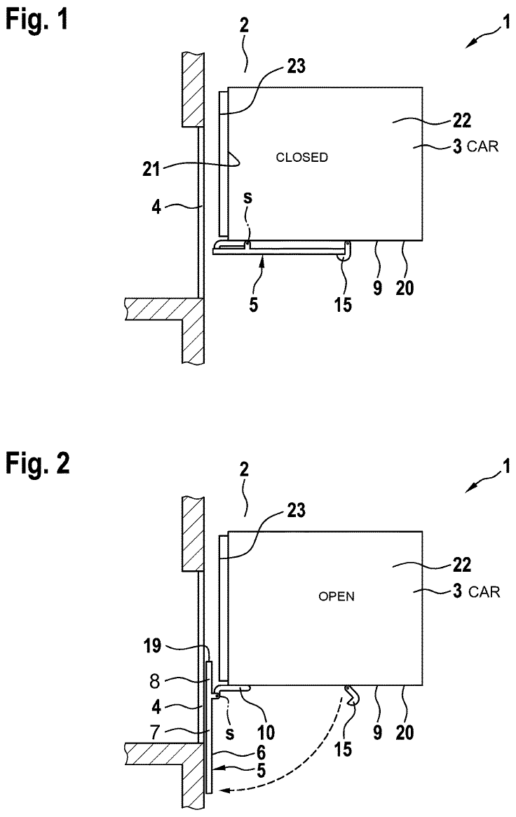

FIG. 1 is a greatly simplified view of an elevator installation according to the invention having a cabin which can be moved up and down in an elevator shaft and is equipped with a movable cabin skirt, with the cabin skirt being in a rest position,

FIG. 2 shows the elevator installation from FIG. 1, with the cabin skirt of the cabin being in a blocking position,

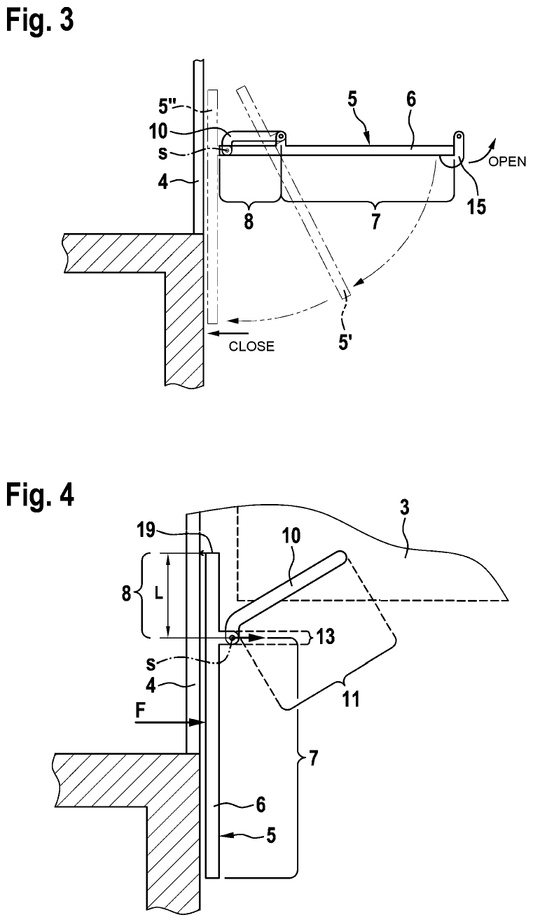

FIG. 3 is an enlarged view of a cabin skirt for the elevator installation according to the invention,

FIG. 4 is a variant of the cabin skirt according to FIG. 3, and

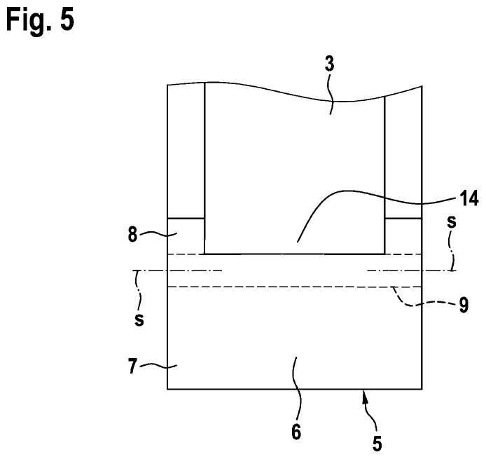

FIG. 5 is a front view of a cabin having a cabin skirt in the blocking position according to an embodiment.

FIG. 1 shows an elevator installation, denoted by 1, for a multi-story building. The building has one elevator shaft 2 or multiple elevator shafts as required. The elevator installation 1 shown here contains a cabin 3 that can be moved vertically up and down in the elevator shaft 2 for the transport of people or goods to individual floors. The cabin 3 has a cabin floor 9, a cabin roof, a front side 21, a rear side opposite the front side and parallel cabin sides 22 connecting the front side and rear side. A cabin door 23 is arranged in the region of the front side 21.

A shaft door 4 is associated with each floor. In addition to the cabin 3, the elevator installation generally has a counterweight, suspension means and a drive, which are not shown here for the sake of simplicity and for reasons of clarity. The drive (e.g., a traction sheave drive) drives the one or more suspension means (for example belts or steel cables) and thus moves the cabin 3 and the counterweight in opposite directions. To guide the cabin 3, guide rails (also not shown here) are arranged in the elevator shaft 2.

A special cabin skirt 5, which is described in detail below, is arranged below the cabin 3. In FIG. 1, the cabin skirt is in a rest position close to the cabin 3, and the cabin skirt is normally located in this position. In the rest position, the cabin skirt is clearly positioned in a horizontal position below the cabin 3 close to the underside 20 of the cabin. The cabin skirt 5 is brought into a blocking position only in special situations, for example for emergency evacuations of people from the cabin 3. FIG. 1 shows the cabin 3 in a position between the floors, in which such an emergency evacuation may be necessary. In order for people to be able to safely get out of the cabin 3 and reach the next floor, the cabin skirt 5 must be moved from the rest position shown in FIG. 1 to the blocking position. This movement takes place after securing means 15 for holding the cabin skirt 5 in the rest position have first been triggered. The cabin skirt 5 is then moved in two phases and brought into the blocking position shown in FIG. 3. The blocking position is the position in which the cabin skirt 5 blocks or covers the gap between the cabin and the floor. In the blocking position, the cabin skirt 5 is clearly directed downward in a vertical position. In the blocking position, the cabin skirt 5 extends in parallel with the shaft wall on the shaft door side.

The aforementioned securing means 15 can, for example, comprise one or at most a plurality of pawls, by means of which the cabin skirt 5 can be held in the rest position on the cabin 3 in the horizontal position on the underside 20 of the cabin 20. The securing means 15 can be controlled or can be operated manually to lift the rest position.

As can be seen from FIG. 2, the cabin skirt 5 is pivotally and displaceably mounted on the cabin 3 by means of a guideway 10. The sequence of movements of the cabin skirt 5 is indicated by dashed lines. First, the cabin skirt 5, after it has been enabled by the securing means 15, falls downward and then pivots. This position of the cabin skirt is indicated by 5′. The cabin skirt 5 is then displaced in the direction of the shaft wall on the shaft door side until it finally reaches the end position shown by 5″.

The guideway 10 can be formed, for example, by a groove. The pivot axis for the pivoting movement is denoted by S. The guideway 10 comprises a linear guide portion 11 (see FIG. 4). In the end position, the horizontal pivot axis S is positioned slightly below with respect to the guide portion 11. For the end position, a downwardly directed and comparatively short vertical end portion 13 adjoins the horizontal guide portion 11. In this position, the cabin skirt 5″ cannot easily be pushed back in the horizontal direction such that the cabin skirt 5″ is pivotally mounted on the cabin 3 in a more or less stable manner. If a horizontal force is exerted on the cabin skirt 5″ from the outside, for example by people getting out of the cabin interior, the pivot axis S cannot retreat in the horizontal direction; the pivot axis S is therefore at least temporarily fixed. When horizontal forces are exerted from the outside, there is a slight pivoting movement, but further pivoting movement is prevented since the upper free end 19 abuts the shaft door 4. The force mentioned here is indicated by an arrow F in FIG. 4.

Since the cabin skirt 5, when it is in the blocking position (5″), can be supported on the shaft doors 4 when horizontal forces are exerted from the outside, it is not necessary to provide additional or special locking means in order to secure the blocking position of the cabin skirt. The shaft doors 4 are usually designed as sliding doors. This ensures that the cabin skirt 5 can also be supported on the shaft door 4 when the shaft door 4 is open for evacuation.

So that the cabin skirt 5 can be brought back from the blocking position into the initial position, i.e., into the aforementioned rest position, the cabin skirt 5 must be raised. After the cabin skirt 5 has been moved slightly upward in the vertical direction, it can be pushed back again along the linear horizontal guide portion 11 of the guideway 10 into the horizontal intermediate position (5′) at the start of the guideway 10. Finally, the cabin skirt 5 only has to be folded back up. If the securing means 15 have corresponding pawls for a latching connection, for example, the cabin skirt 5 latches on the pawl, the cabin skirt 5 is securely held in the rest position again as a result.

For a reliable and safe support of the cabin skirt 5 when it is in the blocking position, the cabin skirt 5 has a part that protrudes upward in relation to the pivot axis S. This protruding part is formed by a segment of the cabin skirt 5 referred to as a support segment 8. The cabin skirt 5 substantially consists of a flat skirt element 6 which is made up of a blocking segment 7 and the aforementioned support segment 8. The blocking segment 7 has the task of closing the gap between the floor and the underside 20 of the cabin. The blocking segment 7 and the support segment 8, which are preferably flush with one another and are thus on the same plane, form a common flat element.

As an example, an extension for forming the pivot axis S is attached to the flat skirt element 6. The extension can be monolithically connected to the flat skirt element 6. The extension can be equipped with an articulated cam, for example. In this case, the cabin skirt 5 can preferably have a pair of articulated cams which engage in a pair of parallel guide grooves to form the guideway 10 on the cabin 3.

A preferred variant of a guideway 10 for the pivotable and displaceable mounting of the cabin skirt 5 is shown in FIG. 4. The skirt element 6 of the cabin skirt 5 is designed substantially the same as in the first embodiment. The guideway 10 has an oblique linear guide portion 11 and a comparatively short, vertical linear end portion 13 which adjoins the guide portion 11. In the present case, the guide portion 11 is inclined, for example, by an angle of 30° with respect to the horizontal. The angle of inclination of the guide portion 11 with respect to the horizontal can preferably be between 10° and 45°.

As already mentioned, the cabin skirt 5 has a blocking segment 7 which adjoins the pivot axis S and projects downward in the blocking position in order to close the gap between the floor and the underside 20 of the cabin and a support segment 8 which adjoins the pivot axis S and projects upward in the blocking position in order to positionally secure the vertical position of the cabin skirt. The support segment 8 preferably has a length L, measured from the pivot axis S as far as the free upper end 19, of at least 10 cm.

The end portion 13 has a front end for setting the blocking position, the front end corresponding to an end point of the guideway 10. The front end forms the lowest point of the guideway 10.

In FIG. 4 it can be clearly seen that the pivot axis S is temporarily fixed in the blocking position. When the force is exerted, the cabin skirt 5 can only be pivoted. However, since the vertical cabin skirt 5, which extends almost in parallel with the shaft door 4, is practically directly next to the shaft door 4, the pivoting movement is substantially prevented or only a slight pivoting movement is possible since the cabin skirt 5 abuts the shaft door 4.

It can be seen from the front view of the cabin 3 according to FIG. 5 that the cabin skirt 5 can have a central, preferably approximately rectangular, cutout 14 in the region of the support segment 8. If a particularly large length is selected for the support segment 8, the cutout 14 can ensure that no disruptive obstacles arise at the door threshold and therefore people can be evacuated from the cabin unhindered.

1-9. (canceled)

10. An elevator installation including a car moveable up and down in an elevator shaft, the elevator shaft having a plurality of shaft doors, the car comprising:
a car skirt arranged on the car and being moveable between a horizontal rest position and a vertical blocking position; and
wherein when the car skirt is in the blocking position and the car is adjacent to one of the shaft doors, the car skirt is adapted to be supported on the one shaft door.

11. The elevator installation according to claim 10 wherein the car skirt is movable relative to the car about a horizontal pivot axis, the car skirt having a blocking segment that adjoins the pivot axis and projects downward when the car skirt is in the blocking position thereby closing a gap between a floor at which the one shaft door is located and an underside of the car, and the car skirt having a support segment that adjoins the pivot axis and projects upward when the car skirt is in the blocking position to positionally secure the car skirt vertically.

12. The elevator installation according to claim 11 wherein the support segment has a length of at least 10 cm.

13. The elevator installation according to claim 10 wherein the car skirt is pivotally and displaceably mounted on the car by a guideway.

14. The elevator installation according to claim 13 wherein the guideway has a guide portion for displacing the car skirt to bridge a horizontal distance between the car and the one shaft door.

15. The elevator installation according to claim 14 wherein the guide portion is an oblique guide portion.

16. The elevator installation according to claim 14 wherein the guideway has a vertical end portion that adjoins the guide portion.

17. The elevator installation according to claim 16 wherein the end portion has a front end for setting the blocking position of the car skirt, the front end forming a lowest point of the guideway such that the pivot axis of the car skirt is temporarily fixed in place.

18. The elevator installation according to claim 11 wherein the car skirt has a central, preferably approximately rectangular, cutout formed in a region of the support segment.

19. The elevator installation according to claim 18 wherein the central cutout is rectangular is shape.

20. An elevator car skirt for use in an elevator installation a car moveable up and down in an elevator shaft, the elevator shaft having a plurality of shaft doors, the car skirt comprising:
a guideway adapted to be attached to an underside of the car;
a skirt element being moveable along the guideway and being rotatable about a horizontal pivot axis at the guideway for movement between a horizontal rest position and a vertical blocking position; and
wherein when the car skirt is attached to the car and in the blocking position and the car is adjacent to one of the shaft doors, the skirt element is adapted to be supported on the one shaft door.

21. The elevator car skirt according to claim 20 wherein the skirt element has a blocking segment that adjoins the pivot axis and projects downward when the car skirt is in the blocking position thereby closing a gap between a floor at which the one shaft door is located and the underside of the car, and the skirt element has a support segment that adjoins the pivot axis and projects upward when the car skirt is in the blocking position to positionally secure the car skirt vertically.

22. The elevator car skirt according to claim 20 wherein the guideway has a guide portion for displacing the car skirt to bridge a horizontal distance between the car and the one shaft door, the guide portion extending one of horizontally and obliquely.

23. The elevator car skirt according to claim 22 wherein the guideway has a vertical end portion that adjoins the guide portion, the end portion having a front end for setting the blocking position of the car skirt, the front end forming a lowest point of the guideway such that the pivot axis of the car skirt is temporarily fixed in place.
